(19) United States
(12) Patent Application Publication
(10) Pub. No.: US 2026/0100907 A1
(43) Pub. Date: Apr. 9, 2026

(54) DOWNLINK LATENCY MANAGEMENT

(71) Applicant: QUALCOMM Incorporated, San Diego, CA (US)

(72) Inventors: Yubing JIAN, San Diego, CA (US); Arnaud MEYLAN, San Diego, CA (US); Yanzhao SONG, Beijing (CN); Krishna BILLURI, San Diego, CA (US)

(21) Appl. No.: 19/111,732

(22) PCT Filed: Nov. 18, 2022
(86) PCT No.: PCT/CN2022/132875

§ 371 Date: Mar. 13, 2025

(51) Int. Cl. H04L 47/12; H04L 47/24; H04L 47/28

(52) U.S. Cl. CPC H04L 47/12; H04L 47/24; H04L 47/28

(57) ABSTRACT

Method and apparatus for a configuration to manage downlink latency. The apparatus detects at least two data streams are in use, where a first stream is latency sensitive. The apparatus throttles at least one second stream based at least on measured network statistics at the network node to optimize performance of the first stream. The apparatus may detect a throttling event based on the measured network statistics that the at least one second stream meets a triggering condition that initiates the throttling of the at least one second stream. The throttling of the at least one second stream is based at least on a bandwidth of the at least one second stream or delay statistics of the at least one second stream.

### TECHNICAL FIELD

The present disclosure relates generally to communication systems, and more particularly, to a configuration to manage downlink latency.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a network node. The device may be a processor and/or a modem at a network node or the network node itself. In some aspects, the network node may comprise a UE, a base station, an apparatus, a device, or a wired or wireless computing system configured to perform any techniques described herein. The apparatus detects at least two data streams are in use, wherein a first stream is latency sensitive. The apparatus throttles at least one second stream based at least on measured network statistics at the network node to optimize performance of the first stream.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of a measured latency.

FIG. 4B is a diagram illustrating an example of a measured latency.

FIG. 5A is a diagram illustrating an example of a gaming server providing gaming data to a device.

FIG. 5B is a diagram illustrating an example of a gaming server and a background server providing data to a device concurrently.

FIG. 6A is a diagram illustrating an example of a gaming server and a background server providing data to a device concurrently.

FIG. 6B is a diagram illustrating an example of throttled background data.

FIG. 7 is a diagram illustrating an example of a TCP header.

FIG. 8 is a call flow diagram of signaling between a network node and a network entity.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

### DETAILED DESCRIPTION

In telecommunication systems, such as wired or wireless systems, latency sensitive applications (e.g., gaming, streaming, or the like) may have end to end latency requirements that may affect usage of such applications. In some instances, end to end latency requirements is becoming more critical, especially in instances where such applications experience high latency rates. Mobile devices (e.g., UEs, personal computers, etc.) may utilize such latency sensitive applications over wired or wireless systems, but such systems may not prioritize latency sensitive traffic over background traffic.

At least one contributing factor leading to high latency for latency sensitive traffic is background TCP traffic. The latency sensitive application traffic and TCP traffic may be buffered in a queue, but due to TCP traffic aiming to take all the bandwidth, the TCP traffic may fill up the queue which may result in an increased queueing delay for application traffic. High latency rate for latency sensitive traffic, such as but not limited to gaming, is a known issue.

Aspects presented herein provide a configuration to manage downlink latency. The configuration may optimize latency for latency sensitive applications where background downlink traffic is throttled while a latency sensitive application is active. At least one advantage of the disclosure is that the configuration may reduce latency for latency sensitive applications which may provide an enhanced user experience.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

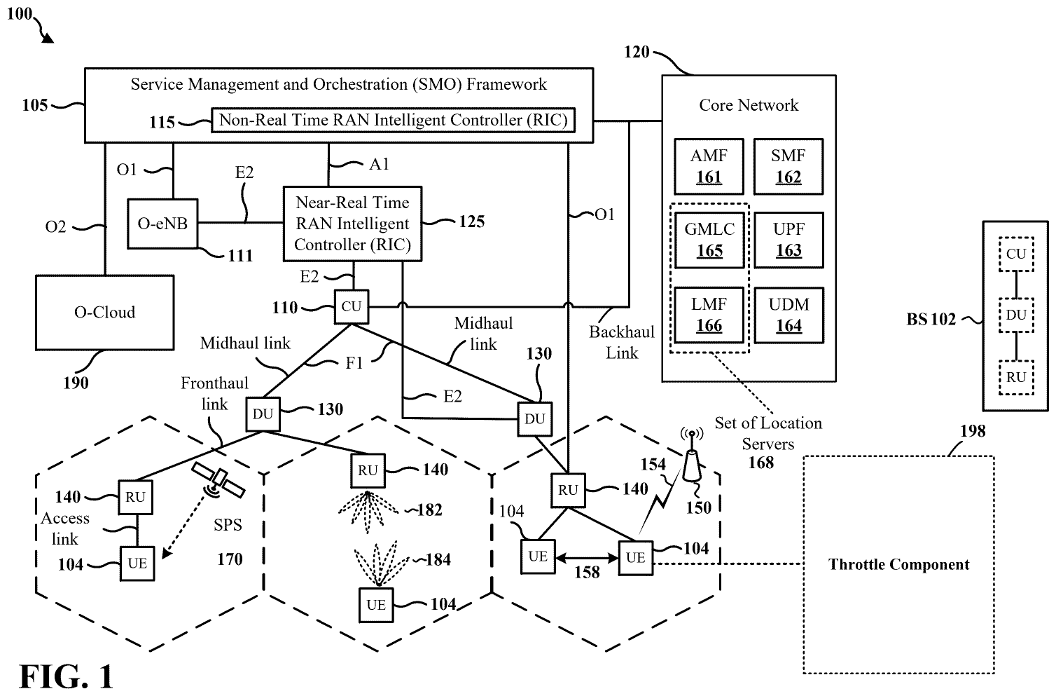

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUS 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the network node may comprise a throttle component 198 configured to detect at least two data streams are in use, wherein a first stream is latency sensitive; and throttle at least one second stream based at least on measured network statistics at the network node to optimize performance of the first stream. As described herein, a network node, which may be referred to as a node, a network node, a communication node, or a wireless node, may be a base station (e.g., any base station described herein), a UE (e.g., any UE described herein), a network controller, an apparatus, a device, a wired or wireless computing system, one or more components, and/or another suitable processing entity configured to perform any of the techniques described herein.

Although the following description may be focused on 5G NR, the concepts described herein may be applicable to other similar areas, such as LTE, LTE-A, CDMA, GSM, and other wireless technologies.

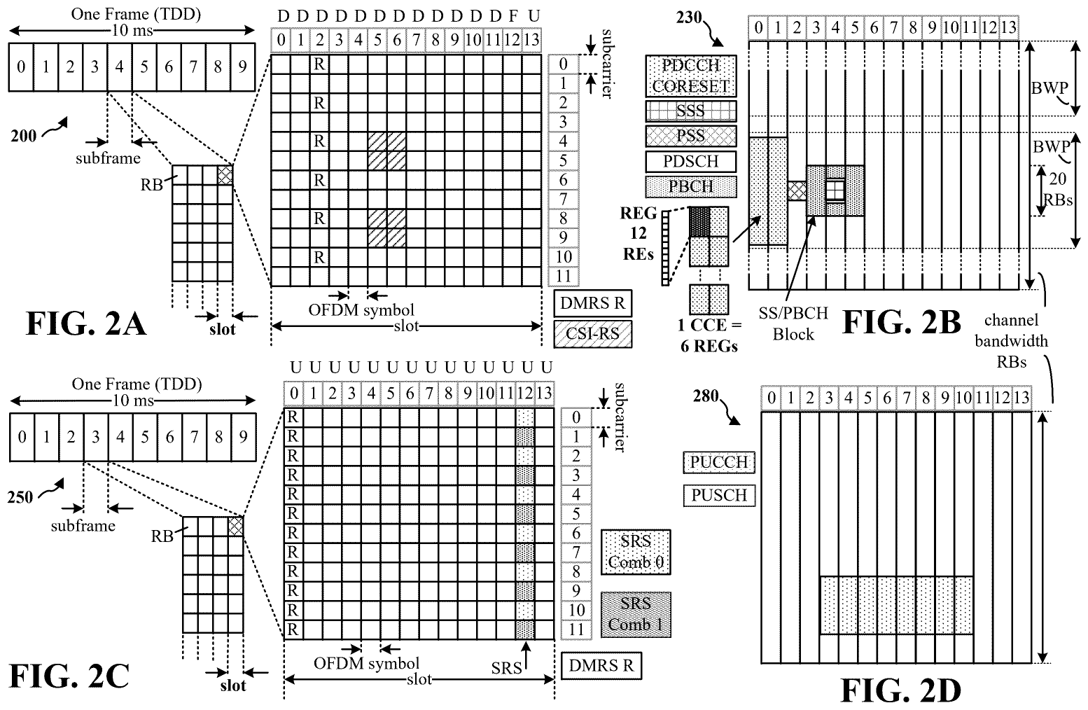

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δƒ = 2^{μ} · 15[KHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

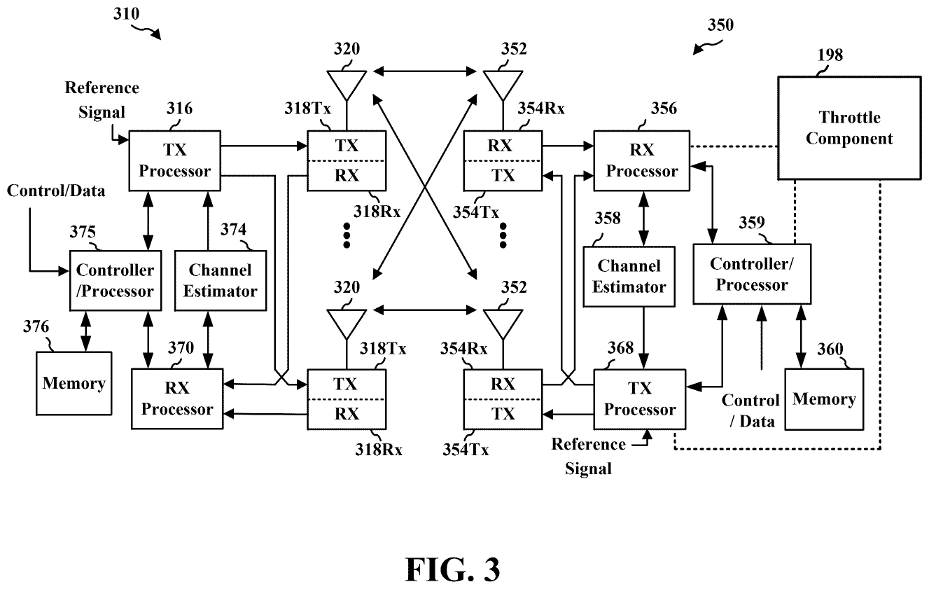

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the throttle component 198 of FIG. 1.

In telecommunication systems, such as wired or wireless systems, latency sensitive applications (e.g., gaming, streaming, or the like) may have end to end latency requirements that may affect usage of such applications. In some instances, end to end latency requirements is becoming more critical, especially in instances where such applications experience high latency rates (e.g., latency rate greater than 200 ms). Mobile devices (e.g., UEs, personal computers, etc.) may utilize such latency sensitive applications over wired or wireless systems, but such systems may not prioritize latency sensitive traffic over background traffic (e.g., transmission control protocol (TCP), user datagram protocol (UDP), quick UDP internet connection (QUIC), or the like).

At least one contributing factor leading to high latency for latency sensitive traffic is background TCP traffic. The latency sensitive application traffic and TCP traffic may be buffered in a queue, but due to TCP traffic aiming to take all the bandwidth, the TCP traffic may fill up the queue which may result in an increased queueing delay for application traffic. For example, latency sensitive traffic (e.g., gaming traffic) may become very high when downloading a data concurrently. High latency rate for latency sensitive traffic, such as but not limited to gaming, is a known issue. For example, some applications (e.g., gaming, streaming, etc.) may include a latency indication that provides latency metrics experienced by the application.

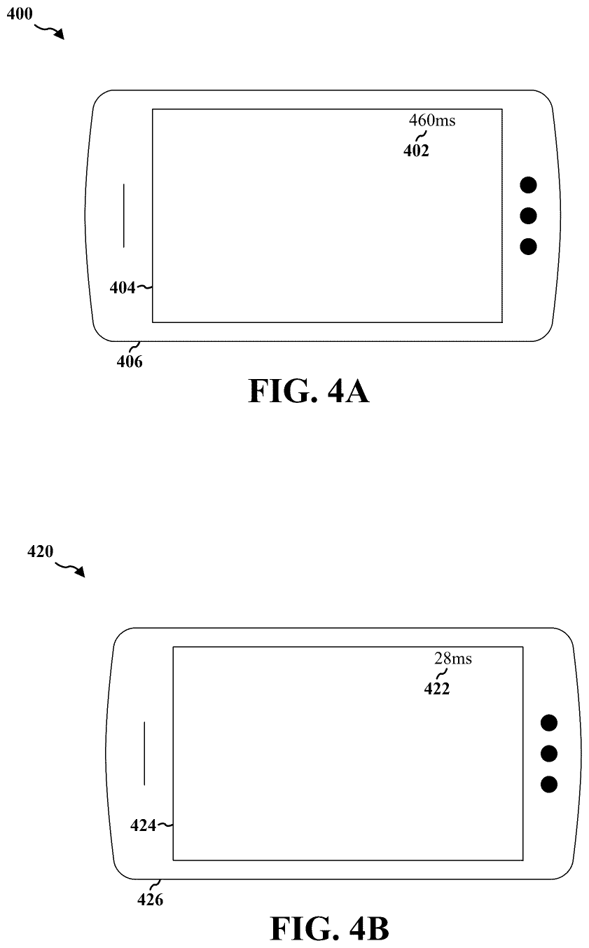

In the example 400 of FIG. 4A, the gaming application may display, on a display 404 of a device 406 (e.g., UE, personal computer, etc.), that the gaming application is experiencing a latency of 460 ms as indicated by the latency indication 402. This latency of 460 ms may be impacted based on background data being downloaded at the same time as the gaming application being active, which may slow down processing of the gaming application traffic and may impact the user experience. In the example 420 of FIG. 4B, the gaming application may display, on the display 424 of the device 426 (e.g., UE, personal computer, etc.), that the gaming application is experiencing a latency of 28 ms as indicated by the latency indication 422. The latency of 28 ms is sufficient to support the gaming application traffic and may be at such level in instances where no background data is being downloaded at the same time as the gaming application is active. The latency examples of 460 ms and 28 ms are intended to be non-limiting examples of latency that may be experienced by the gaming application, and the disclosure is not intended to be limited to the examples disclosed herein.

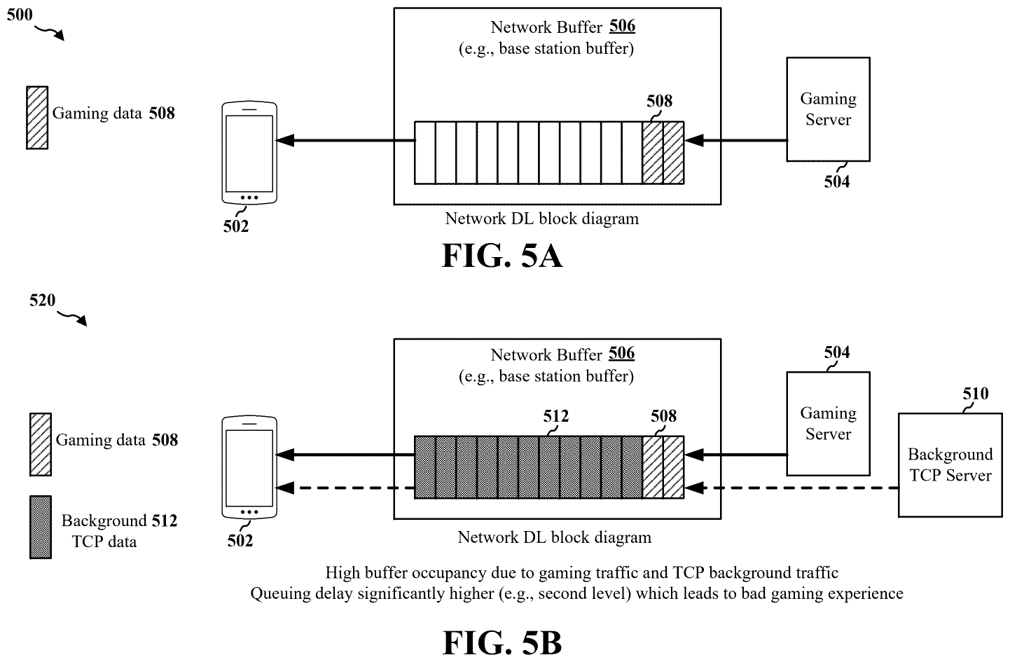

In the example 500 of FIG. 5A, the gaming server 504 is providing gaming data 508 to the device 502 via the network buffer 506. The device 502 may receive the gaming data 508 via a wired or wireless network. The network buffer 506 has a low occupancy with only the gaming data 508 present, which may provide a low end to end latency between the device 502 and the gaming server 504 due to a limited queue size and queuing latency. In the example 520 of FIG. 5B, the gaming server 504 is providing gaming data 508 to the device 502 via the network buffer 506, and the background TCP server 510 is also providing background TCP data 512 to the device 502 via the network buffer 506. The network buffer 506 may have a high occupancy due to the presence of both the gaming data 508 and the background TCP data 512. The high buffer occupancy at the network buffer 506 may result in an increased or significantly higher queuing delay which may lead to a bad or degraded gaming experience for the user. The network often uses the same buffer for latency sensitive traffic and background traffic, as it is difficult for the network to identify the content/application of each flow. The network also often uses one buffer per device, such that a large buffer for a first device will not impact the buffer of the second device. There is an opportunity for each device to manage the downlink traffic to control its own queuing. The bad or degraded gaming experience may occur due in part an increase in latency due to the background TCP data being received concurrently with the gaming data 508. Traffic of latency sensitive applications may get delayed due to large queuing delays caused by the background data being received concurrently with the gaming data. As such, adjusting background traffic behavior may assist active latency sensitive applications.

Aspects presented herein provide a configuration to manage downlink latency. The configuration may optimize latency for latency sensitive applications where background downlink traffic is throttled while a latency sensitive application is active. At least one advantage of the disclosure is that the configuration may reduce latency for latency sensitive applications which may provide an enhanced user experience. At least another advantage of the disclosure is that the configuration may maximize the throughput while minimizing the latency, by enhancing the transport protocol with information available at a user device.

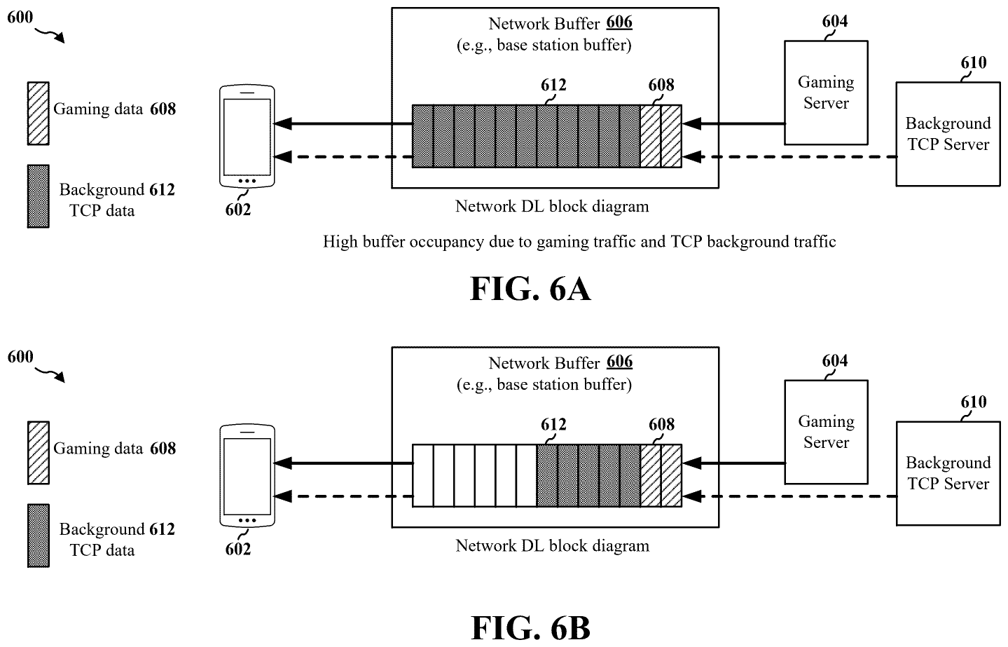

With reference to diagram 600 of FIG. 6A, a gaming server 604, or a server for other latency sensitive application such as but not limited to extended reality (XR), virtual reality (VR), video conferencing, or real time control, may provide data 608 to a device 602 via the network buffer 606. A background TCP server 610 may also provide background TCP data 612 to the device 602 via the network buffer 606 at the same time, such that the network buffer 606 may experience a high buffer occupancy rate due to data 608 and background TCP data 612. As discussed in FIG. 5B, the high occupancy rate at the network buffer 606 may result in an increased or significantly higher queuing delay for that device that may lead to a bad or degraded experience for the user. The disclosure provides a configuration to control behavior of a background data stream (e.g., TCP, UDP, QUIC, or the like) to limit or minimize the downlink background traffic that a background server may send to optimize queuing latency, while controlling the throughput to an optimal level. Optimizing queuing latency may allow for latency sensitive applications to receive corresponding application data and background data, concurrently, without significantly impacting or affecting the user experience of the latency sensitive or background data application.

In some aspects, as shown for example in FIG. 6B, the gaming server 604 may provide data 608 to a device 602 via the network buffer 606. A background TCP server 610 may also provide background TCP data 612 to the device 602 via the network buffer 606 at the same time. However, instead of the network buffer 606 experiencing a high buffer occupancy rate due to the background TCP data 612 filling up the network buffer, the behavior of the background TCP data is controlled to limit the downlink background TCP traffic. In some aspects, the background TCP traffic may be throttled to limit the amount of background data that the network may send to the device 602. For example, the throttling of the background data may be configured in such a manner that the server sends a limited amount of background traffic in one round trip time (RTT). The throttling of the background data limits the amount of in-flight background traffic that is sent to the device 602 via the network buffer 606, such that the network buffer 606 does not encounter or experience an increased queuing delay due to the background traffic and latency sensitive traffic being sent to the device simultaneously.

In some aspects, the speed of the background data may be throttled based on the configuration of the background data. In some instances, the receive buffer size may be reduced, a transmit buffer size may be reduced, a window scaling configuration may be reduced, or congestion control parameters may be limited. In some aspects, the speed of the background data may be throttled based on a header of the background data or the header of acknowledgements applicable for the background data. The header of the background data or the header of acknowledgements applicable for the background data may be adjusted to reduce a receiver window size or to reduce a window scaling factor. In some aspects, the speed of the background data may be throttled based delaying the transmission of acknowledgement or based on an acknowledgement shaping. For example, an acknowledgement shaping speed may be reduced, or by dropping downlink background data segments to trigger congestion control. In some aspects, the speed of the background data may be throttled based on reducing the rate of uplink transmissions or by dropping some downlink background segments.

In instances where the latency sensitive application is active, the throttling of the background data stream (e.g., TCP, UDP, QUIC, etc.) may be triggered by one or more triggering conditions. For example, a triggering condition may comprise instances where any background traffic is transmitted for a period of time that exceeds a threshold. In some aspects, the threshold may comprise 1 second, such that the throttling of the background traffic occurs if the background traffic is transmitted for longer than 1 second.

In some aspects, the throttling of the background data may be based on a bandwidth delay product (BDP) estimation. The throttling may occur on a per background data stream basis. For example, the BDP may be estimated based on downlink actual average throughput and the RTT and may be based on the following equation: BDP(t)=dl_tput(t)*rtt(t). The RTT may be estimated based on an initial RTT (iRTT), a latency estimation for the network and core network, or a timestamp. In some aspects, the BDP may be estimated based on a target BDP, where target_BDP(t)=target_tput(t)*rtt(t).

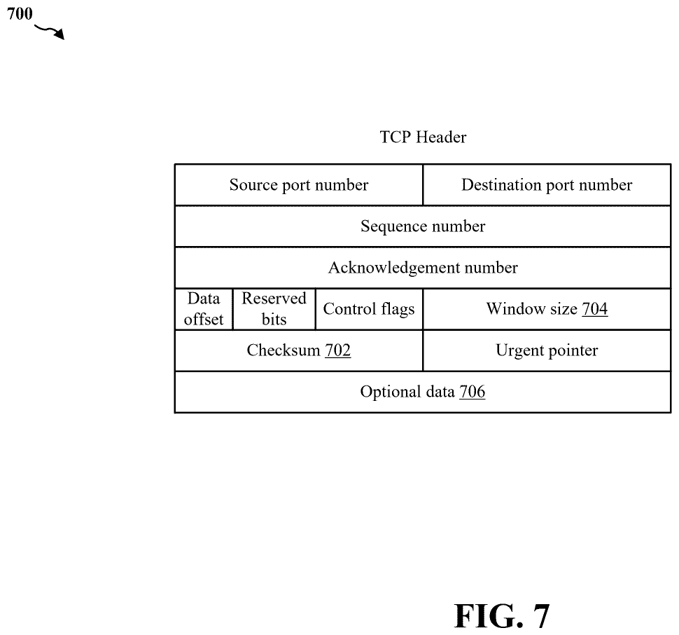

In some aspects, the throttling may be triggered when any background data is active, when high latency for high priority or latency sensitive application is detected, when the background data stream reaches full bandwidth, or based on a detection of low latency requirement. The device may detect the low latency requirement based on a request for low latency operation from the operating system, based on detecting an application requesting low latency being active or based on identification of the traffic as low latency traffic. Background traffic may be throttled to limit the background data stream that the server can transmit in one RTT to minimize queuing latency. For example, with reference to FIG. 7, a TCP header 700 may be modified at either a window scaling field which may comprise a plurality of bits within optional data 706, a window size 704, or both. The window size 704 may indicate an amount of traffic the server may send in one RTT. The window scale within optional data 706 may be modified to increase the maximum window size, such that a scaled window size may be the product of the default window size and a window scale factor. For example, the scaled or calculated window size may be based on: scaled/calculated window size=window size*2^{scale factor}. The checksum 702 may also be adjusted in view of the adjustments to the window size 704 and/or the window scaling field within optional data 706. A smaller scaled window size may result in lower queuing latency, which in turn may lead to lower end to end delay.

In some aspects, throttling the background data flow may include the identification of the setting for the receiver window parameter. For example, to identify the settings of the calculated window size that is equal or greater than the target BDP, where the target_bdp(t)≤window_size*2^{scale factor}. An optimal scale factor and window size may be calculated by identifying a minimum scale factor that satisfies: 65535*2^{scale factor}≥target_bdp(t), then identify a minimum window size that satisfies: window_size*2^{min_scale_factor}≥target_bdp(t), to determine the pair of min_scale factor, min_window_size that satisfies the requirements.

In some aspects, the latency may be optimized for a data flow associated with a latency sensitive application (e.g., gaming, streaming, etc.) or a data flow identified as having a high priority. For example, the user device (e.g., UE or personal computer) may have access to a wired or wireless network and may receive an indication that a certain data flow is a high priority data flow and may have low latency requirements. In such instances, the high priority data flow may comprise latency sensitive data and may have priority over any other data flow. In some aspects, to optimizing the latency for data flows may be based on a throttle receiver window size of the background data flow. A minimum BDP of the background data flow may be maintained in an effort to achieve a maximum bandwidth for the latency sensitive application. The throttling of the background data flow may be triggered based on at least one of a high priority latency sensitive flow is active. For high priority latency sensitive data flows, the latency sensitive application may request a preferred downlink having a level 2 or greater. In some aspects, the background data flow may comprise latency sensitive data or may require a large throughput such that the background data flow is not throttled. In some aspects, the background data flow may comprise an indication indicating the large throughput requirements. In some aspects, the device may receive an indication that the background data flow requires a large throughput. In some aspects, the throttling of the background data flow may occur if the background data flow reaches a large bandwidth. In such instances, any background data flow not from the latency sensitive application may be considered as a background data flow.

Once the throttling commences, the throttling may be applied for each individual background data flows. An estimated throttled target BDP using an actual downlink average throughput of the background data flow and iRTT, where BDP=tput*RTT. The target BDP may correspond to a BDP used to throttle a receiver window size for the background data flow. The receiver window size is associated with the background data flow. The iRTT may be measured for the background data flow during the connection establishment phase for the flow (three-way handshake). A minimum throughput may be considered for each background data flow to prevent instances of a zero throughput and BDP. A growth factor may allow the background data flow throughput to grow based on the target BDP, which may prevent instances of the background data flow being stuck with a low bandwidth. An estimated minimum RTT may be estimated based on RAN and a core network latency, to prevent iRTT becoming too large. The target BDP may be expressed as follows:

$$target\_bdp ( t ) = max ( d1\_tput ( t ) , min\_tput ) * growth\_factor * min ( irtt , estimated\_min \_rtt ( t ) ) ,$$

where target_bdp(t) is the target BDP,
dl_tput(t) is the downlink throughput,
min_tput is the minimum throughput,
growth_factor is the growth factor,
estimated_min_rtt is the estimated minimum RTT.

In some aspects, for each background data flow acknowledgement transmitted, the receiver window (recv_wnd) may be upper bounded by recv_wnd(t)=target_bdp(t), where a default receiver window is recorded. If the original value of receiver window is less, then the original value is maintained.

In some aspects, if one or more conditions to throttle the background data flow is not satisfied, then the throttling of the background data flow may terminate and default values may be set for one or more parameters. For example, the receiver window size may revert or be re-written to the default value for each uplink background data flow acknowledgement.

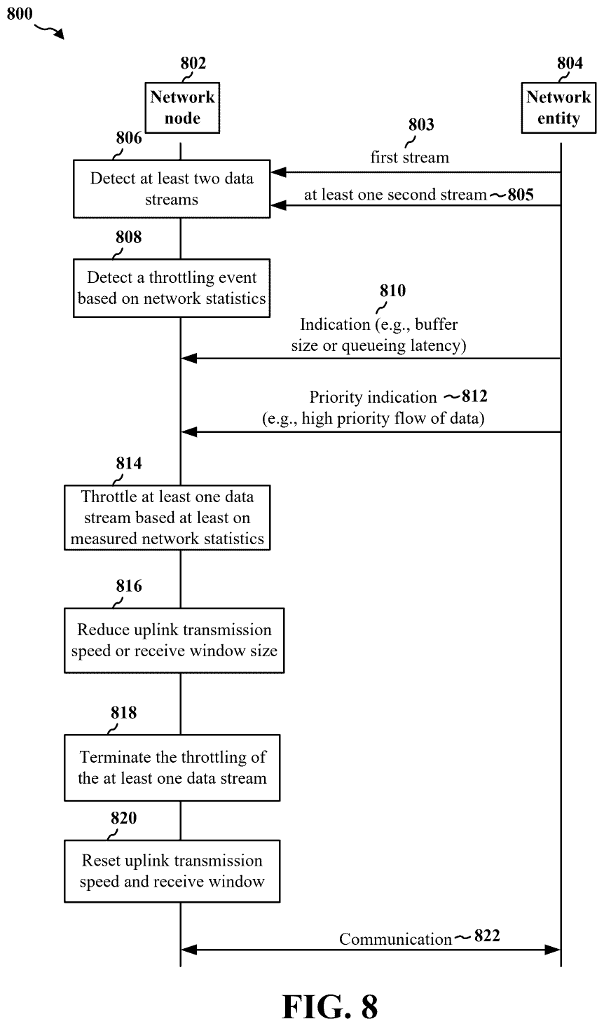

FIG. 8 is a call flow diagram 800 of signaling between a network node 802 and a network entity 804. The network entity 804 may be configured to provide at least one cell. The network node 802 may be configured to communicate with the network entity 804. For example, in the context of FIG. 1, the network entity 804 may correspond to base station 102, and the network node 802 may correspond to at least UE 104. In another example, in the context of FIG. 3, the network entity 804 may correspond to base station 310 and the network node 802 may correspond to UE 350.

At 806, the network node 802 may detect at least two data streams (e.g., 803, 805). The at least two data streams may comprise a first stream 803 and at least one second stream 805. The first stream 803 may be determined to be latency sensitive. The network node 802 may determine that the first stream is latency sensitive. The network node may detect the at least two data streams based on any of the aspects described in connection with FIGS. 4A-7.

At 808, the network node 802 may detect a throttling event based on measured network statistics that at least one second stream (e.g., 805) meets a triggering condition that initiates a throttling of the at least one second stream. The throttling of the at least one second stream may be based at least on a bandwidth of the at least one second stream or delay statistics of the at least one second stream. In some aspects, the triggering conditions may comprise at least one of the first stream comprising a high priority data stream, the at least one second stream being received for a time duration that exceeds a timer or the bandwidth of the at least one second stream exceeding a threshold, reception of an indication of a latency of the high priority data stream exceeding a latency threshold, an actual queue latency or a buffer size exceeding a queue latency time duration threshold or a buffer size threshold, or an estimated queue latency based on a traffic pattern exceeding the queue latency time duration threshold. The network node may detect the throttling event based on any of the aspects described in connection with FIGS. 4A-7.

At 810, the network entity 804 may provide an indication comprising a buffer size or a queueing latency at a network entity 804. The network node 802 may receive the indication comprising the buffer size or the queueing latency at the network entity. The network node 802 may receive, from the network entity 804, the indication comprising the buffer size or the queueing latency at the network entity. The network node may provide an indication based on any of the aspects described in connection with FIGS. 4A-7.

At 812, the network entity 804 may provide a priority indication indicating that a flow of data (e.g., first stream 803) is a high priority flow of data. The network node 802 may receive the priority indication from the network entity 804. In some aspects, the high priority flow of data may comprise latency sensitive traffic. The latency sensitive traffic may have priority over any of the at least one second stream. The network node may receive the priority indication based on any of the aspects described in connection with FIGS. 4A-7.

At 814, the network node 802 may throttle at least one second stream based at least on measured network statistics at the network node. The network node may throttle the at least one second stream based at least on measured network statistics at the network node to optimize performance of the first stream. In some aspects, the at least one second stream may comprise a plurality of data streams. In such aspects, a throttling of the plurality of data streams may be maintained while prioritizing the first stream. The network node may throttle the at least one second stream based on any of the aspects described in connection with FIGS. 4A-7.

At 816, the network node 802, to throttle the at least one second stream, may reduce an uplink transmission speed or a receiver window size. In some aspects, the reduced uplink transmission speed or the reduced receiver window size may be determined based on a current downlink throughput or an estimated round trip time (RTT). In some aspects, the reduced uplink transmission speed or the reduced receiver window size may be based on the BDP, where the BDP comprises the product of throughput and RTT. In some aspects, a target BDP may be determined for each of the at least one second stream. In some aspects, the target BDP may be based at least on a network bandwidth and an RTT. The RTT may be based on the estimated RTT of the at least one second stream between the network node and a second network node. The network bandwidth may be based on an amount of data associated with the at least one second stream transmitted to the network node. In some aspects, the estimated RTT may be based on at least one of an initial RTT of the at least one second stream between the network node and a second network node, a latency estimation for a radio access network (RAN), a latency estimation for a core network, a timestamp based estimation of an RTT of the at least one second stream, or a traffic pattern based estimation of the RTT of the at least one second stream. The network node may determine the target BDP based on any of the aspects described in connection with FIGS. 4A-7.

At 8, the network node 802, in the throttling the at least one data stream, may terminate the throttling of the at least one data stream. The network node may terminate the throttling of the at least one data stream if a triggering condition that initiates the throttling of the at least one data stream is not satisfied. The network node may terminate the throttling of the at least one data stream based on any of the aspects described in connection with FIGS. 4A-7.

At 820, the network node 802, may reset the uplink transmission speed and a receiver window size to a default value. The network node may reset the uplink transmission speed and the receiver window size to the default value, in response to terminating the throttling of the at least one second stream based on the triggering condition that initiates the throttling of the at least one second stream not being satisfied. The network node may reset the uplink transmission speed and the receiver window size based on any of the aspects described in connection with FIGS. 4A-7.

At 822, the network node 802 may communicate with the network entity 804. The network node 802 may communicate with the network entity while the at least one second stream is throttled, or in response to the termination of the throttling of the at least one second stream.

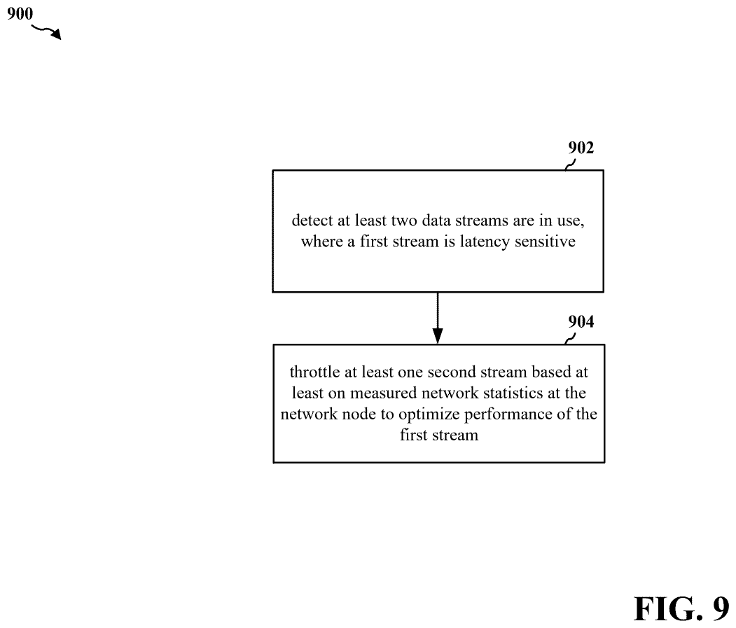

FIG. 9 is a flowchart 900 of a method of telecommunication. The method may be performed by a network node (e.g., the UE 104; the apparatus 1104). One or more of the illustrated operations may be omitted, transposed, or contemporaneous. The method may optimize latency for latency sensitive applications where background downlink traffic is throttled while a latency sensitive application is active.

At 902, the network node may detect at least two data streams are in use. For example, 902 may be performed by throttle component 198 of apparatus 1104. The at least two data streams may comprise a first stream and at least one second stream. The network node may detect that the first stream of the at least two data streams is latency sensitive, based on any of the aspects described in connection with FIGS. 4A-7. In some aspects, the first stream being latency sensitive may be determined to be latency sensitive by the network node based on a detection of low latency requirement.

At 904, the network node may throttle at least one second stream. For example, 904 may be performed by throttle component 198 of apparatus 1104. The network node may throttle the at least one second stream based at least on measured network statistics at the network node, based on any of the aspects described in connection with FIGS. 4A-7. The network node may throttle the at least one second stream based at least on measured network statistics at the network node to optimize performance of the first stream. In some aspects, the at least one second stream may comprise a plurality of data streams. In such aspects, a throttling of the plurality of data streams may be maintained.

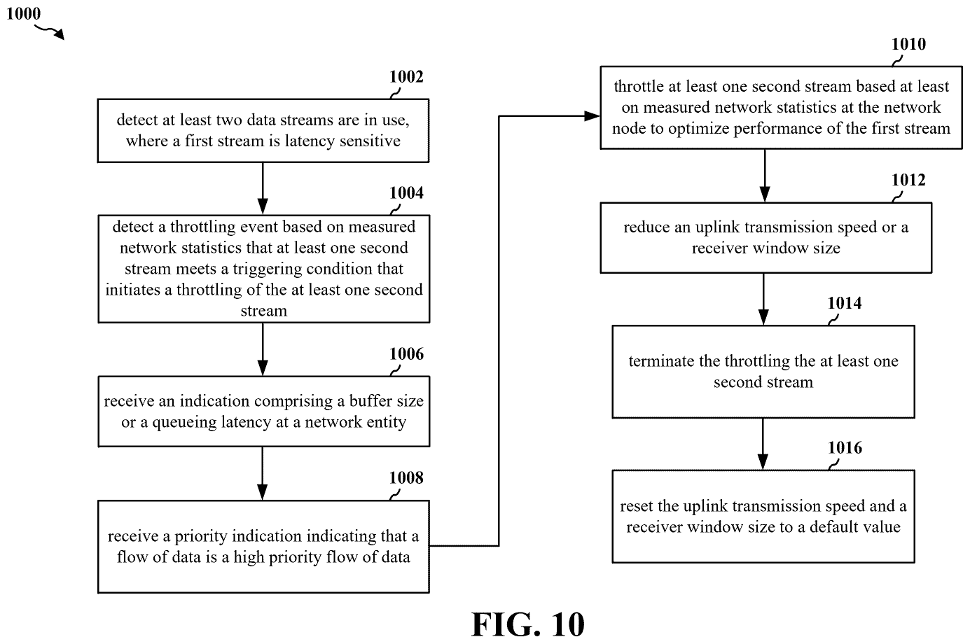

FIG. 10 is a flowchart 1000 of a method of telecommunication. The method may be performed by a network node (e.g., the UE 104; the apparatus 1104). One or more of the illustrated operations may be omitted, transposed, or contemporaneous. The method may optimize latency for latency sensitive applications where background downlink traffic is throttled while a latency sensitive application is active.

At 1002, the network node may detect at least two data streams are in use. For example, 1002 may be performed by throttle component 198 of apparatus 1104. The at least two data streams may comprise a first stream and at least one second stream. The network node may detect that the first stream of the at least two data streams is latency sensitive, based on any of the aspects described in connection with FIGS. 4A-7. In some aspects, the first stream being latency sensitive may be determined to be latency sensitive by the network node based on a detection of low latency requirement.

At 1004, the network node may detect a throttling event. For example, 1004 may be performed by throttle component 198 of apparatus 1104. The network node may detect the throttling event based on measured network statistics that the at least one second stream meets a triggering condition that initiates a throttling of the at least one second stream, based on any of the aspects described in connection with FIGS. 4A-7. The throttling of the at least one second stream may be based at least on a bandwidth of the at least one second stream or delay statistics of the at least one second stream. In some aspects, the triggering conditions may comprise at least one of the first stream comprising a high priority data stream, the at least one second stream being received for a time duration that exceeds a timer or the bandwidth of the at least one second stream exceeding a threshold, reception of an indication of a latency of the high priority data stream exceeding a latency threshold, an actual queue latency or a buffer size exceeding a queue latency time duration threshold or a buffer size threshold, or an estimated queue latency based on a traffic pattern exceeding the queue latency time duration threshold.

At 1006, the network node may receive an indication comprising a buffer size or a queueing latency at a network entity, based on any of the aspects described in connection with FIGS. 4A-7. For example, 1006 may be performed by throttle component 198 of apparatus 1104.

At 1008, the network node may receive a priority indication, based on any of the aspects described in connection with FIGS. 4A-7. For example, 1008 may be performed by throttle component 198 of apparatus 1104. The priority indication may indicate that a flow of data (e.g., first stream) is a high priority flow of data. In some aspects, the high priority flow of data may comprise latency sensitive traffic. The latency sensitive traffic may have priority over any of the at least one second stream.

At 1010, the network node may throttle at least one second stream. For example, 1008 may be performed by throttle component 198 of apparatus 1104. The network node may throttle the at least one second stream based at least on measured network statistics at the network node, based on any of the aspects described in connection with FIGS. 4A-7. The network node may throttle the at least one second stream based at least on measured network statistics at the network node to optimize performance of the first stream. In some aspects, the at least one second stream may comprise a plurality of data streams. In such aspects, a throttling of the plurality of data streams may be maintained.

At 1012, the network node, to throttle the at least one second stream, may reduce an uplink transmission speed or a receiver window size, based on any of the aspects described in connection with FIGS. 4A-7. For example, 1012 may be performed by throttle component 198 of apparatus 1104. In some aspects, the reduced uplink transmission speed or the reduced receiver window size may be determined based on a current downlink throughput or an estimated round trip time (RTT). In some aspects, the reduced uplink transmission speed or the reduced receiver window size may be based on the BDP, where the BDP comprises the product of throughput and RTT. In some aspects, a target BDP may be determined for each of the at least one second stream. In some aspects, the target BDP may be based at least on a network bandwidth and an RTT. The RTT may be based on the estimated RTT of the at least one second stream between the network node and a second network node. The network bandwidth may be based on an amount of data associated with the at least one second stream transmitted to the network node. In some aspects, the estimated RTT may be based on at least one of an initial RTT of the at least one second stream between the network node and a second network node, a latency estimation for a RAN, a latency estimation for a core network, a timestamp based estimation of an RTT of the at least one second stream, or a traffic pattern based estimation of the RTT of the at least one second stream.

At 1014, the network node, in the throttling the at least one second stream, may terminate the throttling of the at least one second stream, based on any of the aspects described in connection with FIGS. 4A-7. For example, 1014 may be performed by throttle component 198 of apparatus 1104. The network node, in the throttling of the at least one second stream, may terminate the throttling of the at least one second stream if a triggering condition that initiates or initiated the throttling of the at least one second stream is not satisfied or no longer satisfied.

At 1016, the network node, in the throttling the at least one second stream, may reset the uplink transmission speed and a receiver window size to a default value, based on any of the aspects described in connection with FIGS. 4A-7. For example, 1016 may be performed by throttle component 198 of apparatus 1104. The network node, in the throttling of the at least one second stream, may reset the uplink transmission speed and the receiver window size to the default value, if the triggering condition that initiates or initiated the throttling of the at least one second stream is not satisfied or no longer satisfied.

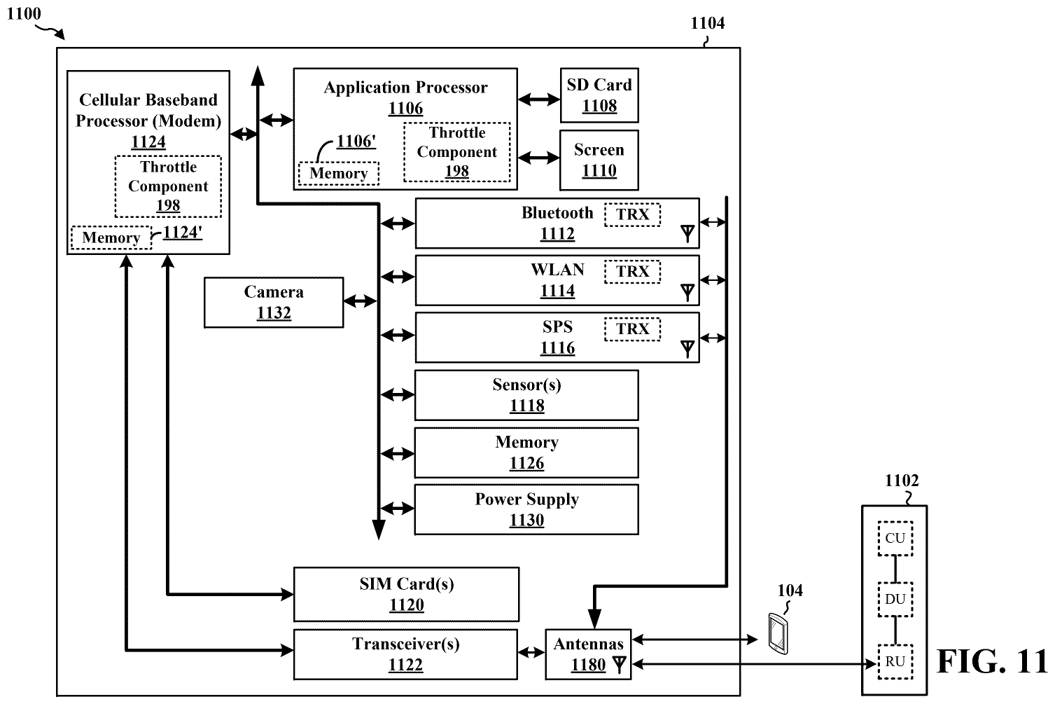

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the component 198 is configured to detect at least two data streams are in use, wherein a first stream is latency sensitive; and throttle at least one second stream based at least on measured network statistics at the network node to optimize performance of the at least one second stream. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for detecting at least two data streams are in use. A first stream is latency sensitive. The apparatus includes means for throttling at least one second stream based at least on measured network statistics at the network node to optimize performance of the at least one second stream. The apparatus further includes means for detecting a throttling event based on the measured network statistics that the at least one second stream meets a triggering condition that initiates the throttling of the at least one second stream. The throttling of the at least one second stream is based at least on a bandwidth of the at least one second stream or delay statistics of the at least one second stream. The apparatus further includes means for reducing an uplink transmission speed or a receiver window size. The apparatus further includes means for terminating the throttling the at least one second stream. The apparatus further includes means for resetting the uplink transmission speed and a receiver window size to a default value. The apparatus further includes means for receiving an indication comprising a buffer size or a queueing latency at a network entity. The apparatus further includes means for receiving a priority indication indicating that a flow of data is a high priority flow of data. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of telecommunication at a network node comprising detecting at least two data streams are in use, wherein a first stream is latency sensitive; and throttling at least one second stream based at least on measured network statistics at the network node to optimize performance of the first stream.

Aspect 2 is the method of aspect 1, further including detecting a throttling event based on the measured network statistics that the at least one second stream meets a triggering condition that initiates the throttling of the at least one second stream, wherein the throttling of the at least one second stream is based at least on a bandwidth of the at least one second stream or delay statistics of the at least one second stream.

Aspect 3 is the method of any of aspects 1 and 2, further includes that the triggering condition comprises at least one of the first stream comprising a high priority data stream, the at least one second stream being received for a time duration that exceed a timer or the bandwidth of the at least one second stream exceeding a threshold, reception of an indication of a latency of the high priority data stream exceeding a latency threshold, an actual queue latency or a buffer size exceeding a queue latency time duration threshold or a buffer size threshold, or an estimated queue latency based on a traffic pattern exceeding the queue latency time duration threshold.

Aspect 4 is the method of any of aspects 1-3, further includes that the at least one second stream comprises a plurality of data streams, wherein a throttling of the plurality of data streams is maintained.

Aspect 5 is the method of any of aspects 1-4, further includes that throttling the at least one second stream further including reducing an uplink transmission speed or a receiver window size.

Aspect 6 is the method of any of aspects 1-5, further includes that the reduced uplink transmission speed or the reduced receiver window size is determined based on a current downlink throughput, an estimated RTT, or a BDP, wherein the BDP comprises a product of a throughput and an RTT.

Aspect 7 is the method of any of aspects 1-6, further includes that a target BDP is determined for each of the at least one second stream.

Aspect 8 is the method of any of aspects 1-7, further includes that a target BDP is based at least on a network bandwidth and an RTT, wherein the RTT is based on an estimated RTT of the at least one second stream between the network node and a second network node, and the network bandwidth is based on an amount of data associated with the at least one second stream transmitted to the network node.

Aspect 9 is the method of any of aspects 1-8, further includes that an estimated RTT is based on at least one of an initial RTT of the at least one second stream between the network node and a second network node, a latency estimation for a RAN, a latency estimation for a core network, a timestamp based estimation of an RTT of the at least one second stream, or a traffic pattern based estimation of the RTT of the at least one second stream.

Aspect 10 is the method of any of aspects 1-9, further includes that if a triggering condition that initiates the throttling the at least one second stream is not satisfied, throttling the at least one second stream further includes terminating the throttling the at least one second stream; and resetting the uplink transmission speed and the receiver window size to a default value.

Aspect 11 is the method of any of aspects 1-10, further including receiving an indication comprising a buffer size or a queueing latency at a network entity.

Aspect 12 is the method of any of aspects 1-11, further including receiving a priority indication indicating that a flow of data is a high priority flow of data, wherein the high priority flow of data comprises latency sensitive traffic, wherein the latency sensitive traffic has priority over any of the at least one second stream.

Aspect 13 is an apparatus for wireless communication at a network node including at least one processor coupled to a memory and at least one transceiver, the at least one processor configured to implement any of Aspects 1-12.

Aspect 14 is an apparatus for wireless communication at a network node including means for implementing any of Aspects 1-12.

Aspect 15 is a computer-readable medium storing computer executable code, where the code when executed by a processor causes the processor to implement any of Aspects 1-12.

1. An apparatus for telecommunication at a network node, comprising:
a memory; and
at least one processor coupled to the memory and, based at least in part on information stored in the memory, the at least one processor is configured to:
detect at least two data streams are in use, wherein a first stream is latency sensitive; and
throttle at least one second stream based at least on measured network statistics at the network node to optimize performance of the first stream.

2. The apparatus of claim 1, further comprising a transceiver coupled to the at least one processor.

3. The apparatus of claim 1, wherein the at least one processor is configured to:
detect a throttling event based on the measured network statistics that the at least one second stream meets a triggering condition that initiates the throttling of the at least one second stream, wherein the throttling of the at least one second stream is based at least on a bandwidth of the at least one second stream or delay statistics of the at least one second stream.

4. The apparatus of claim 3, wherein the triggering condition comprises at least one of:
the first stream comprising a high priority data stream,
the at least one second stream being received for a time duration that exceed a timer or the bandwidth of the at least one second stream exceeding a threshold,
reception of an indication of a latency of the high priority data stream exceeding a latency threshold,
an actual queue latency or a buffer size exceeding a queue latency time duration threshold or a buffer size threshold, or
an estimated queue latency based on a traffic pattern exceeding the queue latency time duration threshold.

5. The apparatus of claim 1, wherein the at least one second stream comprises a plurality of data streams, wherein a throttling of the plurality of data streams is maintained.

6. The apparatus of claim 1, wherein to throttle the at least one second stream the at least one processor is configured to:
reduce an uplink transmission speed or a receiver window size.

7. The apparatus of claim 6, wherein the reduced uplink transmission speed or the reduced receiver window size is determined based on a current downlink throughput, an estimated round trip time (RTT), or a bandwidth delay product (BDP), wherein the BDP comprises a product of a throughput and an RTT.

8. The apparatus of claim 6, wherein a target BDP is determined for each of the at least one second stream.

9. The apparatus of claim 6, wherein a target BDP is based at least on a network bandwidth and an RTT, wherein the RTT is based on an estimated RTT of the at least one second stream between the network node and a second network node, and the network bandwidth is based on an amount of data associated with the at least one second stream transmitted to the network node.

10. The apparatus of claim 6, wherein an estimated RTT is based on at least one of an initial RTT of the at least one second stream between the network node and a second network node, a latency estimation for a radio access network (RAN), a latency estimation for a core network, a timestamp based estimation of an RTT of the at least one second stream, or a traffic pattern based estimation of the RTT of the at least one second stream.

11. The apparatus of claim 6, wherein if a triggering condition that initiates the throttling the at least one second stream is not satisfied, to throttle the at least one second stream the at least one processor is configured to:
terminate the throttling the at least one second stream; and
reset the uplink transmission speed and the receiver window size to a default value.

12. The apparatus of claim 1, wherein the at least one processor is configured to:
receive an indication comprising a buffer size or a queueing latency at a network entity.

13. The apparatus of claim 1, wherein the at least one processor is configured to:
receive a priority indication indicating that a flow of data is a high priority flow of data, wherein the high priority flow of data comprises latency sensitive traffic, wherein the latency sensitive traffic has priority over any of the at least one second stream.

14. A method of telecommunication at a network node, comprising:
detecting at least two data streams are in use, wherein a first stream is latency sensitive; and
throttling at least one second stream based at least on measured network statistics at the network node to optimize performance of the first stream.

15. The method of claim 14, further comprising:
detecting a throttling event based on the measured network statistics that the at least one second stream meets a triggering condition that initiates the throttling of the at least one second stream, wherein the throttling of the at least one second stream is based at least on a bandwidth of the at least one second stream or delay statistics of the at least one second stream.

16. The method of claim 15, wherein the triggering condition comprises at least one of:
the first stream comprising a high priority data stream,
the at least one second stream being received for a time duration that exceed a timer or the bandwidth of the at least one second stream exceeding a threshold,
reception of an indication of a latency of the high priority data stream exceeding a latency threshold,
an actual queue latency or a buffer size exceeding a queue latency time duration threshold or a buffer size threshold, or
an estimated queue latency based on a traffic pattern exceeding the queue latency time duration threshold.

17. The method of claim 14, wherein the at least one second stream comprises a plurality of data streams, wherein a throttling of the plurality of data streams is maintained.

18. The method of claim 14, wherein the throttling the at least one second stream further comprising:
reducing an uplink transmission speed or a receiver window size.

19. The method of claim 18, wherein the reduced uplink transmission speed or the reduced receiver window size is determined based on a current downlink throughput, an estimated round trip time (RTT), or a bandwidth delay product (BDP), wherein the BDP comprises a product of a throughput and an RTT.

20-30. (canceled)
